(19) United States
(12) Patent Application Publication
(10) Pub. No.: US 2026/0005717 A1
(43) Pub. Date: Jan. 1, 2026

(54) COMMUNICATION APPARATUS THAT COMMUNICATES WITH TARGET APPARATUS AND METHOD USED IN COMMUNICATION APPARATUS

(71) Applicant: JVCKENWOOD Corporation, Yokohama-shi (JP)

(72) Inventor: Kazuomi TACHIGI, Yokohama-shi (JP)

(21) Appl. No.: 19/321,329

(22) Filed: Sep. 8, 2025

Related U.S. Application Data
(63) Continuation of application No. PCT/JP2024/006174, filed on Feb. 21, 2024.

(30) Foreign Application Priority Data
Mar. 9, 2023 (JP) 2023-036536
Dec. 27, 2023 (JP) 2023-220818

(51) Int. Cl. H04B 1/3827; H04B 1/405; H04W 76/45

(52) U.S. Cl. CPC H04B 1/3827; H04B 1/405; H04W 76/45

(57) ABSTRACT

In a wireless communication apparatus, an acquisition unit acquires user's station position information, user's station direction information, further station position information, and further station information. A storage unit stores the further station information and reception time information in association with each other in a further station information list. A search unit searches the further station information list for candidates of a target station located in a direction of the user's station and capable of responding, based on the user's station position information and the user's station direction information, and determines a target station to communicate with by sound from among the candidates of a target station based on at least one of a distance from the user's station to a candidate of a target station retrieved by a search or a time of reception from the candidate of a target station.

### CROSS-REFERENCE TO RELATED APPLICATION

This application is a continuation of application No. PCT/JP2024/006174, and claims the benefit of priority from the prior Japanese Patent Application No. 2023-36536 filed on Mar. 9, 2023 and the prior Japanese Patent Application No. 2023-220818 filed on Dec. 27, 2023, the entire contents of which is incorporated herein by reference.

### BACKGROUND

### 1. Field of the Invention

The present invention relates to technology for a wireless communication apparatus.

### 2. Description of the Related Art

Wireless communication apparatuses that transmit and receive various types of data by using the half-duplex communication method are known (see, for example, Patent Literature 1).

APRS (Automatic Packet Reporting System) is known as a system that uses a wireless communication apparatus as described above and transmits and receives various types of data. In APRS, the data communication frequency used to send and receive data is different from the sound communication frequency used to send transmit receive an audio signal. By transmitting information on the sound communication frequency by using the QSY function, therefore, a need to switch the communication frequency for communication by sound with the transmitting station is communicated. The user who wants to communicate with the transmitting station by sound changes the sound communication frequency on the user's side based on the information on the sound communication frequency transmitted from the transmitting station by using the QSY function and performs sound communication accordingly. QSY is one of the Q codes and is used to mean changing the frequency in operation. The Q code is a three-letter abbreviation that begins with the letter Q used in wireless communication internationally. The QSY function in APRS is a function to exchange information on sound communication frequencies by using the format of AFRS (Automatic Frequency Reporting System) included in the APRS protocol.

The transmitting station uses the QSY function to transmit the frequency information on the sound communication frequency for reception in the transmitting station by embedding the information in the beacon signal. Meanwhile, the receiving station that has received the frequency information displays, on the display unit, a station list that lists transmitting stations that have transmitted the frequency information. This allows the user to check call signs, date and time of reception, QSY frequencies, etc. of further stations received in APRS data communication.

The user selects one of the further stations shown in the station list as the target station. This allows the user to change the sound communication frequency of the sound band of the user's station for sound communication to the QSY frequency of the selected target station.

[Patent Literature 1] JP 2003-348641

### SUMMARY

When the user wants to communicate by sound with a target station in a specific direction, however, it is necessary to search for the target station by checking information on further stations registered in the station list one by one in order to find the target station in a specific direction from the user's station. Therefore, there has been a problem in that much time and effort are consumed.

A communication apparatus according to an embodiment includes: an acquisition unit that acquires user's apparatus position information indicating a position of a user's apparatus, user's apparatus direction information indicating a direction of the user's apparatus, further apparatus position information indicating a position of a further apparatus, and further apparatus information including at least operational status information indicating whether the further apparatus is capable of responding and further apparatus connection destination information indicating connection destination information on the further apparatus; a storage unit that stores the further apparatus information and reception time information indicating a time of reception of the further apparatus information in a further apparatus information list in association with each other; and a search unit that searches the further apparatus information list for candidates of a target apparatus located in a direction of the user's apparatus and capable of responding, based on the user's apparatus position information and the user's apparatus direction information, and that determines a target apparatus to communicate with from among the candidates of a target apparatus based on at least one of a distance from the user's apparatus to a candidate of a target apparatus retrieved by a search or a time of reception from the candidate of a target apparatus.

Another embodiment relates to a wireless communication apparatus. The wireless communication apparatus includes: an acquisition unit that acquires user's station position information indicating a position of a user's station, user's station direction information indicating a direction of the user's station, further station position information indicating a position of a further station, and further station information including at least operational status information indicating whether the further station is capable of responding and further station frequency information indicating a sound communication frequency of the further station; a storage unit that stores the further station information and reception time information indicating a time of reception of the further station information in association with each other in a further station information list; and a search unit that searches the further station information list for candidates of a target station located in a direction of the user's station and capable of responding, based on the user's station position information and the user's station direction information, and that determines a target station to communicate with by sound from among the candidates of a target station based on at least one of a distance from the user's station to a candidate of a target station retrieved by a search or a time of reception from the candidate of a target station.

Another embodiment relates to a method. The method is used in a communication apparatus that includes: acquiring user's apparatus position information indicating a position of a user's apparatus, user's apparatus direction information indicating a direction of the user's apparatus, further apparatus position information indicating a position of a further apparatus, and further apparatus information including at least operational status information indicating whether the further apparatus is capable of responding and further apparatus connection destination information indicating connection destination information on the further apparatus; storing the further apparatus information and reception time information indicating a time of reception of the further apparatus information in association with each other in a further apparatus information list; and searching the further apparatus information list for candidates of a target apparatus located in a direction of the user's apparatus and capable of responding, based on the user's apparatus position information and the user's apparatus direction information, and determining a target apparatus to communicate with from among the candidates of a target apparatus based on at least one of a distance from the user's apparatus to a candidate of a target apparatus retrieved by a search or a time of reception from the candidate of a target apparatus.

Another embodiment relates to a method. The method is used in a wireless communication apparatus that includes: acquiring user's station position information indicating a position of a user's station, user's station direction information indicating a direction of the user's station, further station position information indicating a position of a further station, and further station information including at least operational status information indicating whether the further station is capable of responding and further station frequency information indicating a sound communication frequency of the further station; storing the further station information and reception time information indicating a time of reception of the further station information in association with each other in a further station information list; and searching the further station information list for candidates of a target station located in a direction of the user's station and capable of responding, based on the user's station position information and the user's station direction information, and determining a target station to communicate with by sound from among the candidates of a target station based on at least one of a distance from the user's station to a candidate of a target station retrieved by a search or a time of reception from the candidate of a target station.

Optional combinations of the aforementioned constituting elements, and implementations of the embodiments in the form of methods, apparatuses, systems, recording mediums, and computer programs may also be practiced as modes of the embodiments.

### BRIEF DESCRIPTION OF THE DRAWING

Embodiments will now be described, by way of example only, with reference to the accompanying drawings which are meant to be exemplary, not limiting, and wherein like elements are numbered alike in several Figures, in which:

FIG. 1 is a block diagram showing a configuration of a wireless communication apparatus of the first embodiment;

FIG. 2 is an illustrative front view of the wireless communication apparatus of the first embodiment;

FIG. 3 is a functional block diagram of the control unit of the first embodiment;

FIG. 4A shows an illustrative display screen on the display unit for QSY setting in a related-art wireless communication apparatus;

FIG. 4B shows an illustrative display screen on the display unit for QSY setting in a related-art wireless communication apparatus;

FIG. 4C shows an illustrative display screen on the display unit for QSY setting in a related-art wireless communication apparatus;

FIG. 4D shows an illustrative display screen on the display unit for QSY setting in a related-art wireless communication apparatus;

FIG. 4E shows an illustrative display screen on the display unit for QSY setting in a related-art wireless communication apparatus;

FIG. 5 is a flow chart of a process in the wireless communication apparatus of the first embodiment;

FIG. 6A-6C show display screens on the display unit for QSY setting in the wireless communication apparatus of the first embodiment;

FIG. 7 is a flowchart of a specific process of step S102 in the wireless communication apparatus of the first embodiment; and

FIG. 8 shows a case where multiple further stations are located around the user's station.

### DETAILED DESCRIPTION

The invention will now be described by reference to the preferred embodiments. This does not intend to limit the scope of the present invention, but to exemplify the invention.

### First embodiment

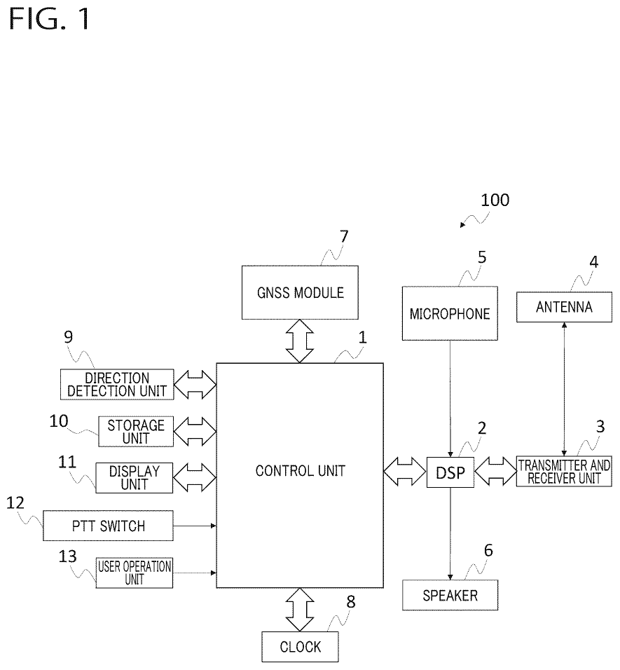

FIG. 1 is a block diagram showing a configuration of a wireless communication apparatus 100 of the first embodiment. As shown in FIG. 1, the wireless communication apparatus 100 includes a control unit 1, a DSP2, and a transmitter and receiver unit 3. Hereinafter, the wireless communication apparatus 100 may be referred to as the user's station.

The control unit 1 controls each feature of the wireless communication apparatus 100. The control unit 1 may include, as exemplary hardware features, an arithmetic circuit provided with a CPU (Central Processing Unit) and a storage device provided with RAM (Random Access Memory) and ROM (Read Only Memory) to implement a program memory, a data memory, etc. The control unit 1 acquires data from each feature of the wireless communication apparatus 100 and arithmetically processes various data in the arithmetic circuit in accordance with the program stored in the storage device.

The DSP (Digital Signal Processor) 2 is a processor for performing a digital signal process. The DSP2 is connected to the control unit 1, the transmitter and receiver unit 3, a microphone 5, and a speaker 6. The transmitter and receiver unit 3 is connected to an antenna 4 for transmitting and receiving a radio wave. The speaker 6 functions as a notification unit.

The transmitter and receiver unit 3 is a circuit block in which a transmitter unit and a receiver unit are configured as an integral part. The transmitter unit and the receiver unit may be configured separately. The transmitter and receiver unit 3 transmits and receives APRS data between the user's wireless communication apparatus 100 (the user's station) and a further wireless communication apparatus by using the half-duplex communication scheme. APRS data includes the call sign of the further station received through APRS data communication, the date and time of reception, the QSY frequency, etc. APRS data may also include operational status information such as position comments. The information related to a further station included in the APRS data may hereinafter be referred to as further station information or QSY information. For convenience, the further station in which the sound communication frequency is set may sometimes be referred to as a QSY station by using the Q code. Further, the sound communication frequency of the QSY station may sometimes be referred to as a QSY frequency. In APRS, the data communication frequency (data band) for transmission and reception of data is different from the sound communication frequency (sound band) for transmission and reception of audio signals. The further wireless communication apparatus may be provided with the same features as the wireless communication apparatus 100 or may be provided with different features. Hereinafter, the further wireless communication apparatuses may be referred to as a further station.

The APRS data received by the transmitter and receiver unit 3 via the antenna 4 is supplied to the DSP2. The DSP2 performs AFSK demodulation in the case of a bit rate of 1200 bps and performs GMSK demodulation in the case of a bit rate of 9600 bps. The DSP2 supplies the demodulated data to the control unit 1.

The control unit 1 can perform an APRS analysis process to display the station list described later on the display unit 11.

When the transmitter and receiver unit 3 receives a modulated wave of an audio signal, the transmitter and receiver unit 3 demodulates the received signal. When the demodulated audio signal includes a signaling signal, the DSP2 decodes the data and supplies the decoded data to the control unit 1, limits the bandwidth of the audio signal and subjects the resultant signal to D/A conversion, and supplies the analog audio signal to the speaker 6.

The DSP2 has the microphone 5 connected to it. The microphone 5 collects the sound originated by the user of the wireless communication apparatus 100, converts collected sound into an audio signal, and supplies the audio signal to the DSP2. The DSP2 subjects the input audio signal to A/D conversion, subjects the converted signal to bandwidth limitation and signaling, and turns the resultant signal into modulation wave.

The transmitter and receiver unit 3 modulates the carrier wave by the modulation wave supplied from the DSP2 to produce an FM modulated signal. The transmitter and receiver unit 3 transmits the FM modulated signal via the antenna 4.

A GNSS module 7, a clock 8, a direction detection unit 9, a storage unit 10, a display unit 11, a PTT (Push To Talk) switch 12, and a user operation unit 13 are further connected to the control unit 1. The control unit 1 controls the operation of each connected unit. The PTT switch 12 may be used to provide the control unit 1 with a PTT signal indicating whether the PTT switch 12 is pressed. The control unit 1 also controls the storage unit 10 to store the further station information described later in a further station information list. The control unit 1 controls the storage unit 10 to store the further station information and the reception time information indicating the time of reception of the further station information in association with each other in the further station information list.

The GNSS module 7 includes an antenna that receives a radio wave from a satellite for Global Navigation Satellite System (GNSS) and a receiver unit that receives a GNSS signal output by the antenna. The GNSS module 7 is a global positioning system (GPS) by way of example. The GNSS module 7 acquires the user's station position information indicating the position of the user's station and supplies the information to the control unit 1. When the wireless communication apparatus 100 is fixed at a predetermined position instead of being movable along with the user, the user's station position information may be stored in the storage unit 10.

The clock 8 is RTC (Real Time Clock) by way of example. The time information of the clock 8 is used as a time stamp.

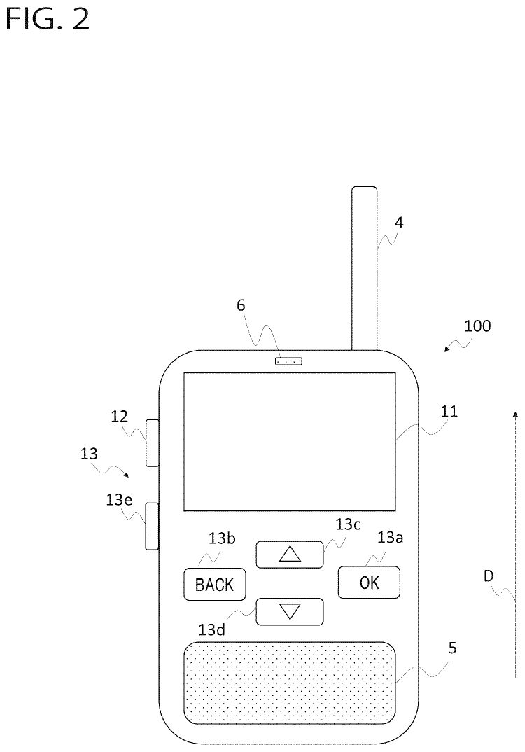

The direction detection unit 9 detects user's station direction information indicating the direction of the user's station. The user's station direction information of the first embodiment indicates the direction of the measurement axis D (see FIG. 2), which is set to define the side along the longitudinal direction of the wireless communication apparatus 100 to which side the antenna is mounted as the reference direction. Alternatively, the measurement axis D may be set to define the direction pointing from the root of the antenna 4 toward the leading end as the reference direction. The direction detection unit 9 is, for example, a geomagnetic sensor or a gyro sensor.

The storage unit 10 stores various settings (such as voice setting described later) in the wireless communication apparatus 100 based on the control by the control unit 1. The storage unit 10 is controlled by the control unit 1 to store the further station information received by APRS data communication. The storage unit 10 is, for example, a non-volatile memory such as EEPROM (Electrically Erasable Programmable Read Only Memory). When a beacon signal is received from a further station by APRS data communication, the storage unit 10 is controlled by the control unit 1 to store the identification information to identify the further station, the further station frequency information indicating the sound communication frequency for receiving the sound in the further station, and the further station position information indicating the position of the further station, which are included in the beacon signal, in association with each other, and to store the associated information in a station list as the further station information. The station list is also called the further station information list. In the further station information list, multiple further station information items are registered in association with the reception time information indicating the time of reception of each further station information item.

The display unit 11 has the function of a notification unit and informs the user of the information based on the control by the control unit 1. The display unit 11 displays predetermined information as a notification to the user. For example, the control unit 1 causes the display unit 11 to display the station list.

When the user originates voice and transmits an audio signal, the user presses the PTT switch 12. The control unit 1 causes the wireless communication apparatus 100 to stand by for reception while the PTT switch 12 is not pressed. The control unit 1 places the wireless communication apparatus 100 in a transmission state while the PTT switch 12 is pressed.

The user operation unit 13 includes various user operation keys described later. The user can move the cursor displayed on the display unit 11 or select and enter a specific item by manipulating the user operation keys. The user operation unit 13 supplies a user operation signal produced by manipulating the user operation key to the control unit 1. Further, the user operation unit 13 may also supply the user operation signal to a search unit 104, a frequency control unit 105, and an output control unit 106 described later.

Referring to FIG. 1, the blank arrow denotes a bus connecting constituting elements. A regular signal connection line may be used instead of a bus.

FIG. 2 is an illustrative front view of the wireless communication apparatus 100 of the first embodiment. The user operation unit 13 receives a user operation input from the user. The user operation unit 13 of the first embodiment includes an “OK” key 13a, a “back” key 13b, a “upward” key 13c, a “downward” key 13d, and a “list” key 13e. The “OK” key 13a is the key for deciding on the item selected by the cursor displayed on the display unit 11. The “back” key 13b is the key to return to the immediately previous input state. The “upward” key 13c and the “downward” key 13d are keys that move the cursor displayed on the display unit 11 up and down, respectively. The “list” key 13e is the key for displaying the station list on the display unit 11. The user operation unit 13 may supply a user operation signal indicating whether the key included in the user operation unit 13 is pressed to the control unit 1.

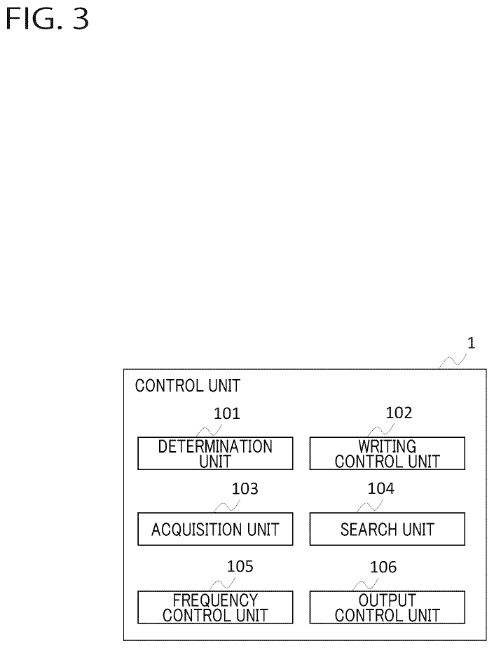

FIG. 3 is a functional block diagram of the control unit 1 of the first embodiment. The control unit 1 includes a determination unit 101, a writing control unit 102, an acquisition unit 103, a search unit 104, a frequency control unit 105, and an output control unit 106. These constituting elements can be implemented by cooperation between hardware resources and software resources or only by hardware resources.

The determination unit 101 performs various determination processes in the first embodiment.

The beacon signal of the further station received by APRS data communication and the time information from the clock 8 are input to the writing control unit 102. The beacon signal contains the QSY information, which is the further station information. Therefore, the writing control unit 102 can write the further station information in the storage unit 10. The further station information includes the identification information to identify the further station, the further station position information indicating the position of the further station, the further station frequency information indicating the sound communication frequency for receiving sound in the further station, the operational status information indicating whether the further station is capable of responding, etc. The writing control unit 102 writes the time of reception of the APRS data in the storage unit 10 based on the time information.

The acquisition unit 103 reads out and acquires the further station information from the storage unit 10. The acquisition unit 103 acquires the user's station position information from the GNSS module 7. The acquisition unit 103 acquires the user's station direction information from the direction detection unit 9.

The search unit 104 searches the further station information registered in the station list, i.e., the further station information list, for the target station candidate information indicating candidates of a target station targeted for sound communication. Hereinafter, the further station targeted for sound communication will be referred to as target stations. The search unit 104 of the first embodiment searches the further station list for the target station candidate information indicating the candidate of a target station corresponding to the direction of the user's station and capable of responding, based on the user's station position information, the further station position information, the user's station direction information, and the operational status information. The search unit 104 of the first embodiment determines the target station targeted for sound communication among the candidates of a target station indicated by the target station candidate information, based on the distance from the user's station to the target station indicated by the target station candidate information retrieved by the search.

The frequency control unit 105 sets, based on the first user operation signal, the sound communication frequency of the user's station at the sound communication frequency of the target station thus determined. The first control signal indicates that a predetermined operation has been performed by the user to apply the further station information on the target station to the user's station.

The output control unit 106 supplies a display signal to the display unit 11 based on the information read out by the acquisition unit 103 from the storage unit 10. The output control unit 106 provides an audio signal to the speaker 6 based on the information read out by the acquisition unit 103 from the storage unit 10 when there is a sound setting.

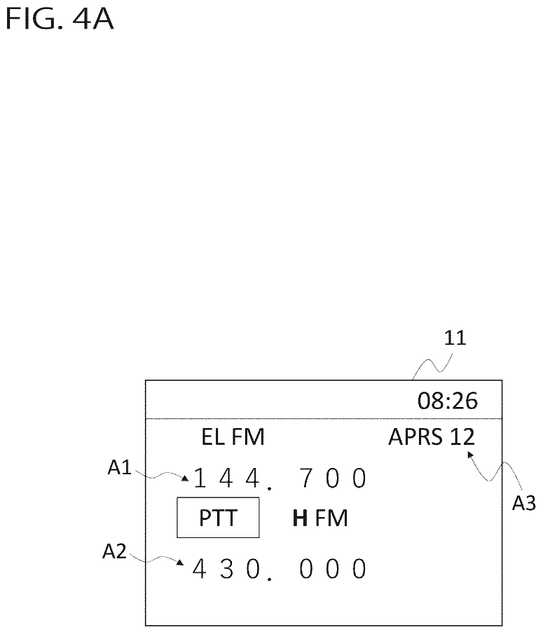

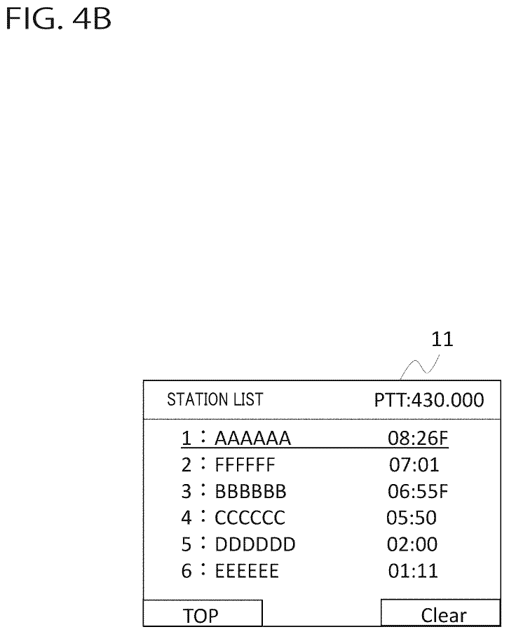

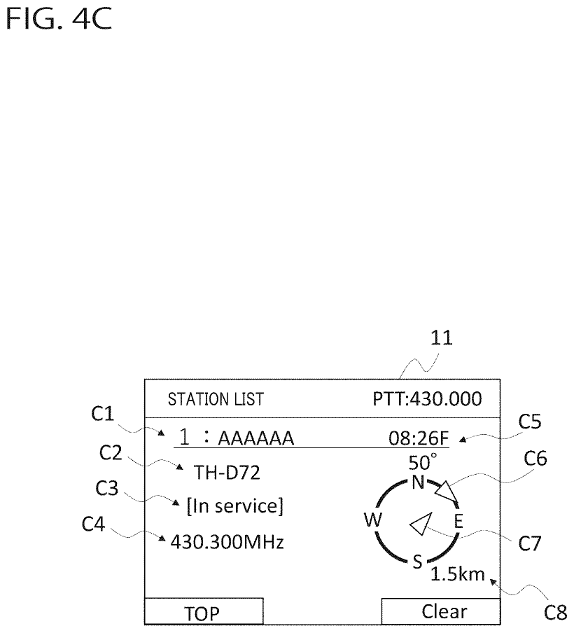

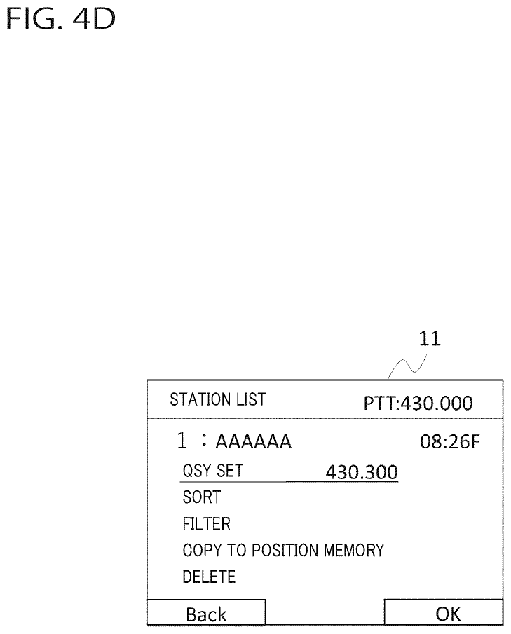

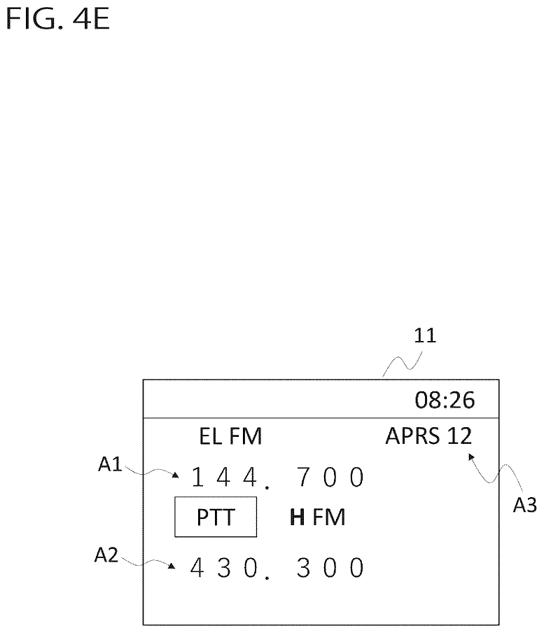

An example of QSY setting in a related-art wireless communication apparatus will be explained as a comparative example by using FIG. 4A-FIG. 4E. FIG. 4A-FIG. 4E show illustrative display screens on the display unit 11 for QSY setting in a related-art wireless communication apparatus.

FIG. 4A shows an example of a standby screen for QSY setting in the wireless communication apparatus 100. The display screen of FIG. 4A shows that information A1 indicates that the data communication frequency of the user's station is 144.700 MHz. Information A2 indicates that the sound communication frequency of the user's station is 430.000 MHz. Information A3 indicates that the user' station is in APRS operation at 1200 bps. When the “list” key 13e is manipulated in the state of FIG. 4A, the station list is displayed as shown in FIG. 4B.

The station list is a listing of information on further stations based on predetermined information such as the position information and the call signs included in the beacon signal received from the further station. As shown in FIG. 4B, the station list shows the call signs of the further stations that have transmitted the beacon signal and the time of reception of the beacon signal in association with each other. A call sign is an identification information for uniquely identifying a further station. For example, the station list indicates that a beacon signal is received from a further station “AAAAAA” at a point of time “08:26”. The further station marked by “F” next to the point of time is a station in which the sound communication frequency is set. In other words, “AAAAAA” and “BBBBBB” are further stations capable of sound communication. In the first embodiment, the further station in which the sound communication frequency is set may be referred to as a QSY station by using the Q code for convenience. Further, the sound communication frequency of the QSY station may be referred to as a QSY frequency for convenience. Selection of a further station displayed in the station list allows the user to check detailed information on the further station. In the example of FIG. 4B, for example, the cursor points to the further station “AAAAAA” with an underline. When the “OK” key 13a is manipulated while the cursor is pointing to the further station “AAAAAA” in the station list, the station list detail screen of FIG. 4C is displayed.

The station list detail screen of FIG. 4C shows further station information on the further stations “AAAAAA”. The station list detail screen shows, as the further station information on the further station “AAAAAA”, a call sign C1, type information C2, a position comment C3, and a status text C4. The station list detail screen also shows a reception time C5 associated with the further station information on the further station “AAAAAA”. The station list detail screen also shows further station direction information C6, user's station direction information C7, and distance information C8.

The type information C2 represents information such as the model number of the apparatus of the further station. For example, the type information C2 indicates “TM-D72”, etc.

The position comment C3 is information that shows the current status of the further station. In other words, the position comment C3 is the operational status information that indicates whether the further station is currently in operation and is capable of responding. The operational status information may be included in the further station information received through APRS data communication. For example, the operational status information indicates “In Service”, etc. “In Service” indicates that operations like messaging and sound communication are possible. The operational status information indicates “Off Duty” when the operations like messaging and sound communication are not possible.

The status text C4 indicates arbitrary text information. When the further station is a QSY station, for example, the sound communication frequency of the further station is displayed at the beginning of the text as in “430.300 MHz . . . ”.

The further station direction information C6 indicates the direction of the further station. The further station direction information C6 is determined based on the position information on the user's station and the further station information on the further station “AAAAAA”. The user's station direction information C7 indicates the direction of the user's station. The distance information C8 indicates the distance between the user's station and the further station. In the example of FIG. 4C, the distance information C8 indicates that the further station “AAAAAA” is located 1.5 km away from the user's station.

The user can check detailed information on the further station “AAAAAA” such as the direction, distance, and sound communication frequency of the further station “AAAAAA”, by referring to the display screen of FIG. 4C. When the user manipulates a predetermined key such as the “OK” key 13a in the display screen of FIG. 4C in association with the determination to communicate with the further station “AAAAAA”, the station list menu screen of FIG. 4D is displayed.

FIG. 4D shows a list of processes to be performed for the further station “AAAAAA”. In the example of FIG. 4D, the cursor points to the item “QSY set” at the sound communication frequency of 430.300 MHz for performing QSY for the further station “AAAAAA” with an underline. When the “OK” key 13a is manipulated while the QSY set is pointed to by the cursor, the sound communication frequency of the user's station is changed to the sound communication frequency 430.300 MHz of the further station “AAAAAA”, and the standby screen after the change in the sound communication frequency shown in FIG. 4E is displayed.

The standby screen of FIG. 4E includes the same detail as the standby screen of FIG. 4A except that information A2 indicates that the sound communication frequency of the user's station is 430.300 MHz. Thereafter, sound communication with the further station is started by manipulating the PTT switch 12.

In this way, in the QSY setting in a related-art wireless communication apparatus, it is necessary, in order to set the sound communication frequency of the user's station at the sound communication frequency corresponding to the target station in a particular direction from the user's station, to search the station list for a target station in the particular direction from the user's station and select the target station by performing a predetermined key operation. Therefore, there is a problem that much time and effort are consumed.

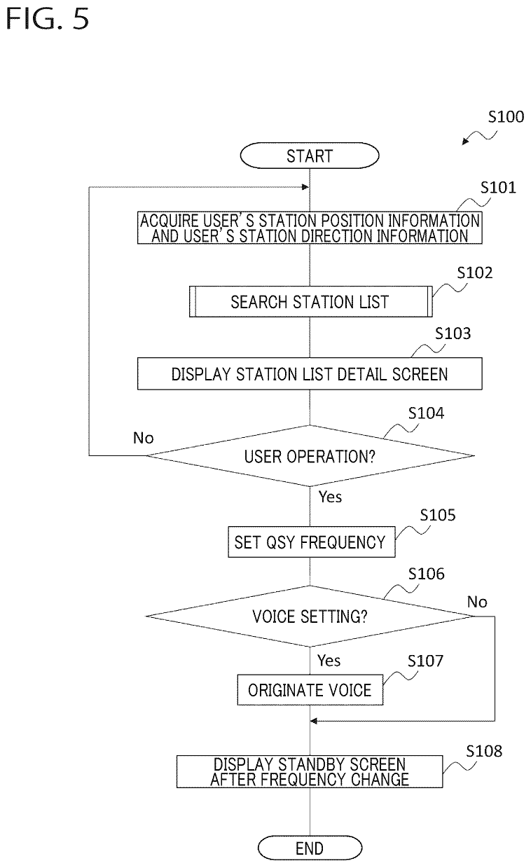

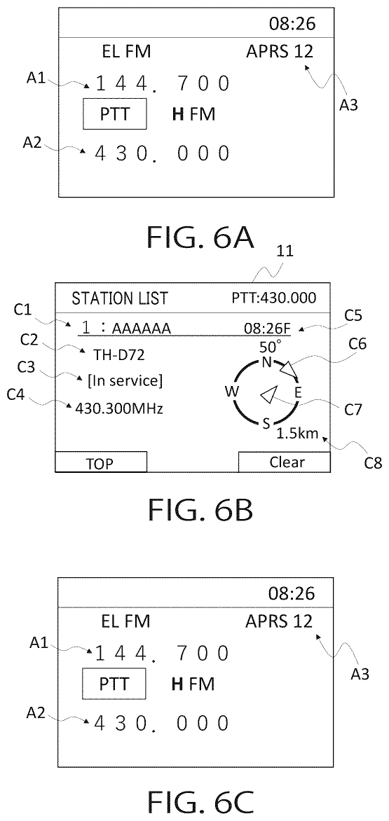

In view of the foregoing, an example of QSY setting in the wireless communication apparatus 100 of the first embodiment is described. FIG. 5 is a flow chart of a process S100 for QSY setting of the control unit 1 of the first embodiment. FIG. 6A-6C show display screens on the display unit 11 for QSY setting in the wireless communication apparatus of the first embodiment. FIG. 6A shows an illustrative standby screen for QSY setting in the wireless communication apparatus, which screen is similar to the standby screen of FIG. 4A. The process S100 shall start from the standby screen of FIG. 6A.

In step S101, the acquisition unit 103 acquires the user's station position information and the user's station direction information.

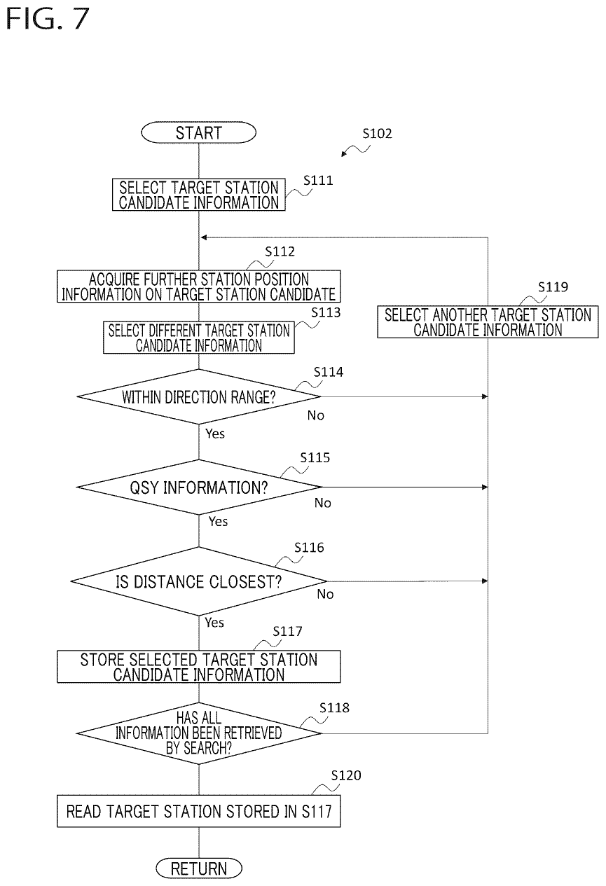

In step S102, the search unit 104 searches the the station list for the target station candidate information including the operational status information indicating that the further station is capable of responding, based on the “list” key 13e being manipulated. The search scheme in step S102 will be described later by using FIG. 7. In the first embodiment, the target station candidate information on the candidates of a target station includes the operational status information indicating that the target station is capable of responding. The target station candidate located within a predetermined direction range relative to the user's station and closest to the user's station is retrieved and determined to be the station targeted for sound communication. When the wireless communication apparatus 100 is oriented east (90°), for example, the target station candidate information that includes the operational status information indicating that the station is capable of responding and that indicates the closest distance to the user's station within a predetermined direction range from the east (90°) direction is retrieved by a search from the station list. It is assumed that the further station “AAAAAA” is determined to be the station targeted for sound communication in step S102. In this case, the target station candidate information including the operational status information indicating that the target station is capable of responding is subject to the search by way of example, but it is not necessary to target the search as in this example. For example, all target station candidate station information included in the station list may be subject to the search.

In step S103, the output control unit 106 displays the station list detail screen of the target station determined from the target station candidate information retrieved by the search in step S102. FIG. 6B is an illustrative station list detail screen of the first embodiment, which is similar to the station list detail screen of FIG. 4C. In the example of FIG. 6B, the station list detail screen for the further station “AAAAAA” is shown because the further station “AAAAAA” is determined to be the further station for sound communication in step S102. In this case, the display unit 11 is caused to function as a notification unit so as to display the detail screen for the determined target station, but application of the present disclosure is not limited to this. The speaker 6 can be caused to function as a notification unit, and detailed information on the determined target station may be voiced through the speaker 6.

In step S104, the determination unit 101 determines whether a predetermined user operation for setting the sound communication frequency of the user's station at the sound communication frequency of the target station is received, based on the first user operation signal. For example, the determination unit 101 determines whether the manipulation of the “OK” key 13a by the user is received as a user operation signal within a predetermined time. When a predetermined user operation is received (Yes in step S104), the process S100 proceeds to step S105. When a predetermined user operation is not received (No in step S104), the process S100 returns to step S101. In this process, the predetermined user operation may be, for example, the manipulation of any user operation key 13. Further, the predetermined user operation may be a user operation that involves a sequence of pressing user operation keys 13 or a combination of keys pressed at the same time.

In step S105, the frequency control unit 105 sets the sound communication frequency of the user's station at the QSY frequency of the further station determined from the target station candidate information retrieved by the search in step S102. This induces a status in which the user can communicate with the further station “AAAAAA” by sound by manipulating the PTT switch 12.

In step S106, the determination unit 101 determines whether there is a voice setting. For example, the determination unit 101 makes a determination by reading the presence or absence of a voice setting from the storage unit 10. If there is a voice setting (Yes in step S106), the process S100 proceeds to step S107. If there is no sound setting (No in step S106), voice is not originated, and the process S100 proceeds to step S108.

In step S107, the output control unit 106 originates a voice “QSY”, “transmission source call sign (AAAAAA)”, and “QSY Frequency (430.300 MHz)” from the direction of the further station (50°) direction in the example of FIG. 6B) through the speaker 6. In this example, the speaker 6 functions as a notification unit that communicates the further station information.

In step S108, the output control unit 106 displays the standby screen after the change in the sound communication frequency shown in FIG. 6C. The standby screen of FIG. 6C contains the same detail as the standby screen of FIG. 6A except that information A2 indicates that the sound communication frequency of the user's station is 430.300 MHz. Thereafter, the user can start sound communication with the further station “AAAAAA” by manipulating the PTT switch 12.

After step S108, the process S100 is terminated.

In step S102, the search unit 104 determines the target station by searching the station list for the target station candidate information based on the information indicating that the “list” key 13e has been manipulated, but the embodiment is not limited to this. In an alternative configuration, the search unit 104 may, for example, automatically search the station list for the target station candidate information based on a predetermined event and without requiring the manipulation of the “list” key 13e. In this case, the frequency control unit 105 may automatically set the sound communication frequency of the user's station at the QSY frequency of the target station indicated by the target station candidate information retrieved by the search. For example, the predetermined event may be a change in the user's station position information or the user's station direction information, and the search unit 104 may search the station list for the target station candidate information in response to the predetermined event to determine the target station. In this case, the search unit 104 searches, in step S102, the station list for the target station candidate information based on the manipulation of the “list” key 13e. Instead of searching the station list for the target station candidate information based on the manipulation of the “list” key 13e, the search unit 104 may search the station list for the target station candidate information based on the occurrence of the predetermined event. For example, the search unit 104 may search the station list for the target station candidate information based on a change in the user's station position information or the user's station direction information as the predetermined event.

In step S104, the determination unit 101 determines whether a predetermined user operation is received based on the first user operation signal, but application of the present disclosure is not limited to this. The determination process of step S104 may be skipped, and control may proceed to step S105 so that the frequency control unit 105 may set the sound communication frequency of the user's station at the QSY frequency of the further station that has been determined as the case arises. With this configuration, the sound communication frequency of the user's station is set by the frequency control unit 105 at the QSY frequency of the further station that has been determined as the case arises. As a result, the user can produce a status in which sound communication with the further station is possible by manipulating the PTT switch 12.

FIG. 7 shows a specific process of step S102.

In step S111, the search unit 104 selects, from the station list, the target station candidate information including the operational status information indicating that the station is capable of responding. The search unit 104 may randomly select the target station candidate information from the target station candidate information in the station list including the operational status information indicating that the station is capable of responding, or the search unit 104 may select the target station candidate information by using a particular selection criterion. Hereinafter, the candidate of a target station indicated by the selected target station candidate information will be referred to as “selected target station candidate”.

In step S112, the search unit 104 acquires the further station position information related to the selected target station candidate. For example, the search unit 104 reads out and acquires the further station position information from the storage unit 10 via the acquisition unit 103.

In step S113, the search unit 104 calculates the direction of the selected target station candidate from the user's station, based on the user's station position information and the further station position information.

In step S114, the search unit 104 determines whether the selected target station candidate is located within a predetermined direction range relative to the user's station based on the direction calculated in step S113 and the user's station direction information. For example, the search unit 104 determines whether the selected target station candidate is located within a range of ±5° as the predetermined direction range relative to the direction of the user's station. The direction range may have an arbitrary value instead of ±5°. When the selected target station candidate is located within the predetermined direction range (Yes in step S114), step S102 proceeds to step S115. When the selected target station candidate is not located within the predetermined direction range (No in step S114), step S102 proceeds to step S119.

In step S115, the search unit 104 determines whether the selected target station candidate has QSY information, which is the further station information. Specifically, the search unit 104 determines whether the sound communication frequency is set in the selected target station candidate. When the selected target station candidate has QSY information (Yes in step S115), step S102 proceeds to step S116. If the selected target station candidate does not have QSY information (No in step S115), step S102 proceeds to step S119.

In step S116, the search unit 104 determines whether the selected target station candidate has the closest distance to the user's station among the target station candidates determined to have QSY information in step S115, based on the user's station position information and the further station position information. If the distance is closest (Yes in step S116), step S102 proceeds to step S117. If the distance is not closest (No in step S116), step S102 proceeds to step S119.

In step S117, the search unit 104 stores the selected target station candidate information in the storage unit 10. For example, the search unit 104 stores, in the storage unit 10, the registration number and the call sign of the target station candidate in the station list.

In step S118, the search unit 104 determines whether all further station information in the station list has been retrieved by the search. When all information has been retrieved by the search (Yes in step S118), step S102 proceeds to step S120. When not all information has been retrieved by the search (No in step S118), step S102 proceeds to step S119.

In step S119, the search unit 104 selects the target station candidate information different from the target station candidate information that has been retrieved in the search so far in step S102. The search unit 104 may randomly select another target station candidate information from the station list or may select another target station candidate information by using a particular selection criterion. Thereafter, step S102 proceeds to step S112, and steps S112-S119 are repeatedly executed until it is determined in step S119 that all items have been retrieved by the search. When the target station candidate information is stored in step S117 and then it is determined that it is determined that the distance is closest by referring to further target station candidate information in step S116 (Yes in step S116), therefore, the target station candidate information hitherto stored is replaced and updated by the further target station candidate information.

In step S120, the search unit 104 reads out the target station candidate stored in step 117 closest to the user's station within the predetermined direction range and determines the target station candidate thus read out to be the target station to communicate with by sound.

After step S120, the process S100 proceeds to step S103.

Thus, in the first embodiment, the search unit 104 searches for the target station candidate information corresponding to the direction of the user's station and capable of responding, based on the user's station position information and the user's station direction information, and determines the candidate station to communicate with by sound from among the candidates of a target station indicated by the target station candidate information, based on the distance from the user's station to the candidate of a target station indicated by the target station candidate information retrieved by the search. This configuration saves the time and effort for finding a target station in a particular direction from the user's station from the station list and performing a predetermined key operation.

In the first embodiment, the frequency control unit 105 changes the sound communication frequency of the user's station to the sound communication frequency of the determined target station in response to the first user operation signal. According to this configuration, the sound communication frequency of the user's station can be changed to the sound communication frequency of the target station. Therefore, it is possible to reduce the time and effort related to setting the frequency.

In the first embodiment, the search unit 104 subjects the further station located within a predetermined direction range relative to the direction of the user's station to a search for the target station candidate information. According to this configuration, a particular target station is automatically retrieved by the search by, for example, just orienting the user's station in the direction where the particular target station is located. Therefore, it is possible to communicate with a particular target station by sound easily.

A description will now be given of a variation to the first embodiment.

When the output control unit 106 receives a second user operation signal indicating that a predetermined second user operation for preventing the further station information on the target station that is displayed from changing has been performed in the wireless communication apparatus 100, the output control unit 106 may fix the display content on the display unit 11 so that the further station information on the target station displayed on the display unit 11 does not change. When the frequency control unit 105 receives a third user operation signal indicating that a predetermined third user operation for applying the further station information on the target station to the user's station has been performed in the wireless communication apparatus 100, the frequency control unit 105 may change the sound communication frequency of the user's station to the sound communication frequency of the target station displayed on the display unit 11. For example, manipulating the “list” key 13e as the second user operation while the station list detail screen of FIG. 6B is being displayed causes the output control unit 106 to fix the station list detail screen. This ensures that the station list detail screen does not change even if the direction of the user's station changes. When the user confirms the desired target station by checking the fixed station list detail screen, the user manipulates the “OK” key 13a to perform the third user operation. This allows the frequency control unit 105 to change the sound communication frequency of the user's station to the sound communication frequency of the target station.

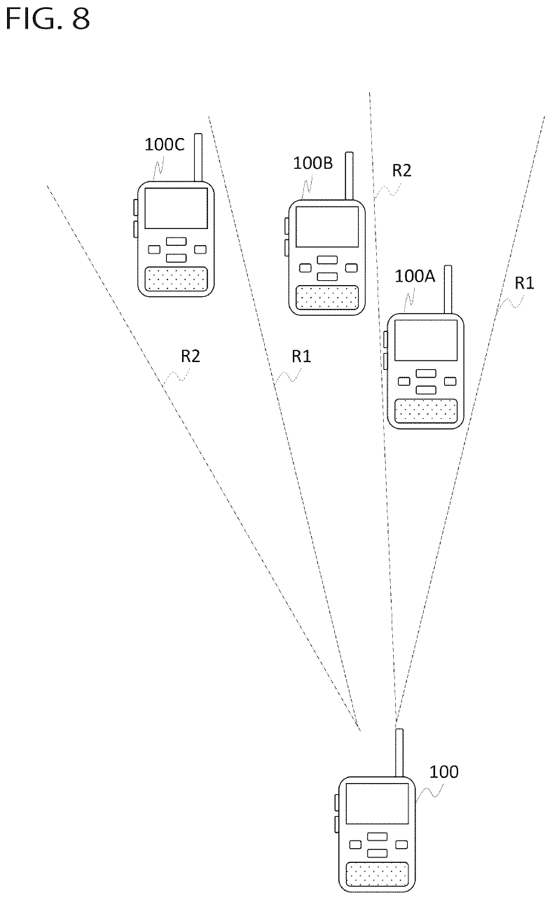

FIG. 8 shows a case where multiple further stations are located around the user's station. In the example of FIG. 8, a further station 100A is assumed to be the target station targeted for sound communication. Even if the user's station is detecting the further stations 100A and 100B within a direction range R1, the user's station may detect the further stations 100B and 100C within a direction range R2 instead of the further station 100A as a result of a change in the direction of the user's station. Therefore, there is a risk that the time and effort are required to change the direction of the user's station to the direction of the further station 100A again. In the present invention, on the other hand, the user can fix the display content on the display unit 11 to prohibit the station list detail screen from being changed, by performing the second user operation immediately upon confirming that the desired other station 100A is displayed. Therefore, it is possible to reduce the time and effort required to adjust the direction of the user's station. The second and third user operations are not limited to user operations that are different from each other, and, for example, they may be the same operation such as manipulating the “OK” key 13a.

In the first embodiment, the target station to communicate with by sound is determined based on the distance between the user's station and the further station, but application of the present disclosure is not limited to this. The target station to communicate with by sound may be determined from among the candidates of a target station indicated by the target station candidate information, based on the reception time associated with the further station information indicated by the target station candidate information retrieved by the search. For example, the further station with the latest time of reception of APRS data may be determined to be the target station to communicate with by sound. This configuration can also provide the same advantage as when the target station to communicate with by sound is determined based on the distance between the user's station and the further station. Therefore, the search unit 104 may determine the further station to communicate with by sound from among the candidates of a target station indicated by the target station candidate information based on at least one of i) the distance from the user's station to the candidate of a target station indicated by the target station candidate information retrieved by the search or ii) the reception time associated with the further station information.

Further, a score can be set such that the closer the distance and the reception time, the higher the score, and the candidate of a target station with the highest score may be determined to be the target station to communicate with by sound. Further, whether the candidate of a target station is “InService” may be included in a condition to determine the target station to communicate with by sound. Therefore, the search unit 104 can determine the target station to communicate with by sound based on at least one of the distance from the user's station to the candidate of a target station or the time of reception of APRS data from the candidate of a target station.

In the first embodiment, it is determined in step S114 whether the target station candidate selected in step S111 or S119 is within the direction range, but application of the present disclosure is not limited to this. Target station candidates within the direction range relative to the user's station may be extracted from all further stations in the station list, and the target station candidate closest to the user's station may be determined to be the target station to communicate with by sound from among the extracted target station candidates.

### Second Embodiment

The second embodiment relates to a communication apparatus 200 configured to connect to the Internet via a cellular network base station or a Wi-Fi (registered trademark) access point, etc. by means of the transmitter and receiver unit 3 and the antenna 4 of the wireless communication apparatus 100 of the first embodiment. The configuration of the communication apparatus 200 of the second embodiment may be similar to the configuration of the wireless communication apparatus 100 of the first embodiment. Further, it is even better if the communication apparatus 200 is configured such that the transmitter and receiver unit 3 connects to the Internet by a wired communication network (not shown).

The acquisition unit of the communication apparatus 200 of the second embodiment acquires the user's apparatus position information indicating the position of the user's apparatus, the user's apparatus direction information indicating the direction of the user's apparatus, the further apparatus position information indicating the position of the further apparatus, and the further apparatus information including at least the operational status information indicating whether the further apparatus is capable of responding or the further apparatus connection destination information indicating the connection destination information for use in communication by the further apparatus. The further apparatus information may include identification information for uniquely identifying the further apparatuses, which is not limited to a call sign. The user's apparatus position information corresponds to the user's station position information of the first embodiment, the user's apparatus direction information corresponds to the user's station direction information of the first embodiment, and the further apparatus position information corresponds to the further station position information of the first embodiment. Further, the further apparatus connection destination information may include, as the identification information to identify and communicate with a target of communication, at least one of the information on the sound communication frequency for sound reception as in the first embodiment, the unique ID that identifies the further apparatus, the IP address that identifies the further apparatus, the MAC address that identifies the further apparatus, IMSI (International Mobile Subscription Identity), IMEI (International Mobile Equipment Identifier), ICCID (IC Card IDentifier), telephone number, etc.

The storage unit of the communication apparatus 200 of the second embodiment stores, in a further apparatus information list, the further apparatus information and the reception time information indicating the time of reception of the further apparatus information in association with each other.

The search unit of the communication apparatus 200 of the second embodiment searches the further apparatus information list for the target apparatus candidate information indicating the candidate of a target apparatus corresponding to the direction of the user's apparatus and capable of responding, based on the user's apparatus position information and the user's apparatus direction information. The search unit of the communication apparatus 200 of the second embodiment determines the target apparatus to communicate with from among the candidates of a target apparatus indicated by the target apparatus candidate information, based on at least one of the distance from the user's apparatus to the candidate of a target apparatus indicated by the target apparatus candidate information retrieved by the search or the reception time associated with the further apparatus information.

The control unit of the communication apparatus 200 of the second embodiment controls the transmitter and receiver unit to communicate with the target apparatus based on the further apparatus connection destination information on the target apparatus determined by the search unit. Further, the control unit of the communication apparatus 200 of the second embodiment may be adapted to control the transmitter and receiver unit to connect to and communicate with an external server via the Internet. When communicating with an external server, the further apparatus information related to the target apparatus may be exchanged. Further, the communication apparatus 200 of the second embodiment may be capable of communicating with the target apparatus via an external server.

In the second embodiment, the target apparatus can be identified by reading the user's station, the further station, and the target station of the first embodiment as the user's apparatus, the further apparatus, and the target apparatus and by performing a process similar to that of the first embodiment.

In the second embodiment, the target apparatus to communicated with is determined based on the distance between the user's apparatus and the further apparatus, but application of the disclosure is not limited to this. The target apparatus to communicate with may be determined from among the candidates of a target apparatus indicated by the target apparatus candidate information, based on the reception time associated with the further apparatus information indicated by the target apparatus candidate information retrieved by the search. For example, the further apparatus with the latest time of reception of data may be determined to be the target apparatus to communicate with. This configuration can also provide the same advantage as in the case of determining the target apparatus to communicate with based on the distance between the user's apparatus and the further apparatus. Therefore, the search unit 104 may determine the target apparatus to communicate with from among the candidates a target apparatus indicated by the target apparatus candidate information, based on at least one of the distance from the user's apparatus to the candidate of a target apparatus indicated by the target apparatus candidate information retrieved by the search or the reception time associated with the further apparatus information.

Further, a score can be set such that the closer the distance and the reception time, the higher the score, and the candidate of a target apparatus with the highest score may be determined to be the target station to communicate with by sound. Further, whether the candidate of a target apparatus is “InService” may be included in a condition to determine the target apparatus to communicate with. Therefore, the search unit 104 can determine the target apparatus to communicate with based on at least one of the distance from the user's apparatus to the candidate of a target apparatus or the time of reception of data from the candidate of a target apparatus.

In the second embodiment, it is determined, as in step S114 of the first embodiment, whether the target apparatus candidate selected as in step S111 or S119 of the first embodiment is within the direction range, but application of the present disclosure is not limited to this. Of all further apparatuses in the station list, target apparatus candidates within the direction range relative to the user's apparatus may be extracted, and the target apparatus candidate closest to the user's apparatus from among the target station candidates extracted may be determined to be the target apparatus to communicate with.

Further, the second embodiment is configured to communicate the information on the target apparatus thus determined to an external server so that the server side can realize various applications by using the information on the target apparatus determined in the communication apparatus 200. For example, the external server can support a large number of applications such as application to a network game, application to a novel communication system configured to search for and communicate with a target apparatus while changing the direction in which the communication apparatus is oriented.

The embodiments are intended to be illustrative only and it will be understood by those skilled in the art that various modifications to combinations of constituting elements and processes are possible and that such modifications are also within the scope of the present invention.

What is claimed is:

1. A communication apparatus comprising:
an acquisition unit that acquires user's apparatus position information indicating a position of a user's apparatus, user's apparatus direction information indicating a direction of the user's apparatus, further apparatus position information indicating a position of a further apparatus, and further apparatus information including at least operational status information indicating whether the further apparatus is capable of responding and further apparatus connection destination information indicating connection destination information on the further apparatus;
a storage unit that stores the further apparatus information and reception time information indicating a time of reception of the further apparatus information in a further apparatus information list in association with each other; and
a search unit that searches the further apparatus information list for candidates of a target apparatus located in a direction of the user's apparatus and capable of responding, based on the user's apparatus position information and the user's apparatus direction information, and that determines a target apparatus to communicate with from among the candidates of a target apparatus based on at least one of a distance from the user's apparatus to a candidate of a target apparatus retrieved by a search or a time of reception from the candidate of a target apparatus.

2. A wireless communication apparatus comprising:
an acquisition unit that acquires user's station position information indicating a position of a user's station, user's station direction information indicating a direction of the user's station, further station position information indicating a position of a further station, and further station information including at least operational status information indicating whether the further station is capable of responding and further station frequency information indicating a sound communication frequency of the further station;
a storage unit that stores the further station information and reception time information indicating a time of reception of the further station information in association with each other in a further station information list; and
a search unit that searches the further station information list for candidates of a target station located in a direction of the user's station and capable of responding, based on the user's station position information and the user's station direction information, and that determines a target station to communicate with by sound from among the candidates of a target station based on at least one of a distance from the user's station to a candidate of a target station retrieved by a search or a time of reception from the candidate of a target station.

3. The wireless communication apparatus according to claim 2,
wherein the search unit
subjects the further station located within a predetermined direction range relative to the direction of the user's station to a search when searching for the candidate of a target station based on the user's station position information and the user's station direction information.

4. The wireless communication apparatus according to claim 2, further comprising:
a notification unit that communicates further station information on the target station determined by the search unit; and
a frequency control unit that changes a sound communication frequency of the user's station,
wherein, when the frequency control unit receives a first user operation signal, the frequency control unit changes the sound communication frequency of the user's station to a sound communication frequency of the target station.

5. The wireless communication apparatus according to claim 2, further comprising:
a display unit; and
an output control unit that controls the display unit to display further information on the target station determined by the search unit; and
a frequency control unit that changes a sound communication frequency of the user's station,
wherein, when the output control unit receives a second user operation signal, the output control unit fixes a display content on the display unit so that the further station information on the target station displayed on the display unit does not change, and
wherein, when the frequency control unit receives a third user operation signal, the frequency control unit changes the sound communication frequency of the user's station to a sound communication frequency of the target station determined.

6. A method used in a communication apparatus, comprising:
acquiring user's apparatus position information indicating a position of a user's apparatus, user's apparatus direction information indicating a direction of the user's apparatus, further apparatus position information indicating a position of a further apparatus, and further apparatus information including at least operational status information indicating whether the further apparatus is capable of responding and further apparatus connection destination information indicating connection destination information on the further apparatus;
storing the further apparatus information and reception time information indicating a time of reception of the further apparatus information in association with each other in a further apparatus information list; and
searching the further apparatus information list for candidates of a target apparatus located in a direction of the user's apparatus and capable of responding, based on the user's apparatus position information and the user's apparatus direction information, and determining a target apparatus to communicate with from among the candidates of a target apparatus based on at least one of a distance from the user's apparatus to a candidate of a target apparatus retrieved by a search or a time of reception from the candidate of a target apparatus.
